(19) United States
(12) Patent Application Publication
(10) Pub. No.: US 2016/0043654 A1
(43) Pub. Date: Feb. 11, 2016

(54) SWITCHING POWER SUPPLY ISOLATION CIRCUIT

(71) Applicant: Guangdong Power Management Technology Co., Limited, Hong Kong (HK)

(72) Inventor: Wei Zeng Deng, Hong Kong (HK)

(73) Assignee: GUANGDONG POWER MANAGEMENT TECHNOLOGY CO., LIMITED

(21) Appl. No.: 14/516,562

(22) Filed: Oct. 16, 2014

(30) Foreign Application Priority Data
Aug. 11, 2014 (CN) 201410393494.4

(51) Int. Cl. H02M 7/06

(52) U.S. Cl. CPC H02M 7/06

(57) ABSTRACT

A switching power supply isolation circuit comprises a switching device, a signal unidirectional transmission device, a unilateral connecting device, an inductance and a control module, wherein the switching device, the inductance and a voltage source are connected in series to form a power supply loop, and the signal unidirectional transmission device, the unilateral connecting device, the inductance and a load are connected in series to form a load loop, both of the switching device and the signal unidirectional transmission device being connected with and controlled by the control module. When the switching device is turned on, the signal unidirectional transmission device is turned off, thereby the inductance starts to store energy; and when the switching device is turned off, the signal unidirectional transmission device is turned on, thereby the inductance starts to releases energy. The present invention has advantages of small volume, high efficiency and low cost.

### CROSS-REFERENCE TO RELATED APPLICATIONS

This present invention claims the benefit of Chinese Patent Application No. CN201410393494.4, filed on Aug. 11, 2014; the contents of which are hereby incorporated by reference.

### FIELD OF THE INVENTION

The present invention relates to switching power supply technology and, in particular, it concerns a switching power supply isolation circuit.

### BACKGROUND OF THE INVENTION

The existing switching power supply circuits include three types of topology structures as follows: 1. buck structure; 2. boost structure; and 3. buck-boost structure, which are shown in FIG. 1a, FIG. 1b and FIG. 1c, respectively. In the buck-mode circuit shown in FIG. 1a, Vo=Vin×D, Vo<Vin; in the boost-mode circuit shown in FIG. 1b, Vo=Vin/(1−D), Vo>Vin; in the buck-boost circuit shown in FIG. 1c, Vo=Vin×D/(1−D), when D<0.5, Vo<Vin, and when D>0.5, Vo>Vin; wherein Vin designates input voltage, Vo designates output voltage, and D designates duty ratio. Viewed from the circuit structures, the above three circuits have one thing in common: the load is always electrically connected with the mains supply (power supply), and generally, such condition is considered as non-isolated state, which is a serious potential security liability.

Some switching power supply circuits are designed with isolation function for reasons of safety. Generally, three types of transformers, including flyback transformer, forward transformer and bridge transformer shown in FIG. 2a, FIG. 2b and FIG. 2c, respectively, are used in the switching power supply circuits, so as to achieve electric isolation. Its working principle is as follows: the switching tube is electrically connected with the inductance of one side of the transformer in series, and the inductance of the other side of the transformer is electrically connected with the load in series; there is no electrical connection between the two inductances (primary inductance and secondary inductance) of the transformer, but they are correlated with each other by means of the action of magnetic field; and according to the electromagnetic induction principle, the transformer can output appropriate energy to the load by applying a certain frequency pulse to the control terminal of the switching tube. Thus, the power supply circuit using a transformer has a function of electrical isolation. However, it has some deficiencies as follows: the transformer needs to be formed by winding two or more than two inductances on the core, which will bring a disadvantage of high cost; the energy exchange relation between the two inductances (primary inductance and secondary inductance) of the transformer is produced by the action of magnetic field, thus, according to the electromagnetic induction principle, there is wastage of energy when the energy exchange relation is produced between the two inductances (primary inductance and secondary inductance) and it will bring a problem of low efficiency.

Thus, although the power supply circuit using a transformer can achieve isolation effect, the transformer has disadvantages of large size and high cost what are the lighting industry scruples about and the efficiency of the isolation circuit becomes a technology node which needs to be broken through.

In view of the above, it is necessary to provide a switching power supply isolation circuit which has advantages of small size, high efficiency and low cost.

### SUMMARY OF THE INVENTION

An object of the present invention is to provide a switching power supply isolation circuit which has advantages of small size, high efficiency and low cost.

To achieve the above object, there is provided an switching power supply isolation circuit, which includes a switching device, a signal unidirectional transmission device, a unilateral connecting device, an inductance and a control module, wherein the switching device, the inductance and a voltage source are connected in series to form a power supply loop, and the unilateral connecting device, the inductance, the signal unidirectional transmission device and a load are connected in series to form a load loop; and both of the switching device and the signal unidirectional transmission device are connected with and controlled by the control module. When the switching device is turned on, the signal unidirectional transmission device is turned off, thereby the power supply loop is working and the inductance starts to store energy; and when the switching device is turned off, the signal unidirectional transmission device is turned on, thereby the load loop is working and the inductance starts to releases energy so as to provide power supply for the load.

Preferably, the switching device is a MOSFET, which has a drain electrode connected with the positive electrode of the voltage source, a source electrode connected with the inductance and a grid electrode connected with a first control terminal of the control module, pulses provided by the control module being output to the MOSFET so as to control the on-off state of the MOSFET.

Preferably, the signal unidirectional transmission device is a photoelectric coupler, which has two input ends respectively connected with a second control terminal and a third control terminal of the control module and two output ends respectively connected with the inductance and the load, pulses provided by the control module being output to the photoelectric coupler so as to control the on-off state of the photoelectric coupler.

Preferably, the unilateral connecting device is a diode, which has a positive electrode connected with the load and a negative electrode connected with the inductance.

Preferably, the control module is a microcontroller unit, three of input/output pins of the microcontroller unit being used as the first control terminal, the second control terminal and the third control terminal, respectively.

Preferably, the circuit further comprises a filter capacitor connected with the load in parallel.

Preferably, the voltage source is a DC voltage source which is formed by using rectifier bridge to rectify mains supply.

Compared with the prior art, the switching power supply isolation circuit of the present invention is mainly constituted of a power supply loop and a load loop, thereby achieving a buck-insulation structure. Viewed from power supply mode of the circuits, the power supply mode of existing circuit, by means of utilizing mutual induction phenomenon produced by a transformer to supply power to a secondary load, will cause magnetic flux loss, which leads to low efficiency, thus, compared with the traditional way, the switching power supply isolation circuit of the present invention has higher efficiency by utilizing induced electromotive force produced by the inductance itself to supply power. Viewed from the volume, there are at least two coils needed to make a transformer while there is just one coil needed to make an inductance, thus, the volume of the transformer will be bigger than that of the inductance on equal terms. Thus, compared with the existing circuit, the switching power supply isolation circuit of the present invention can achieve a smaller size. Viewed from the cost, the production process of the transformer is more complicated, needs longer time and higher cost than that of the inductance on equal terms (the same in-out condition and environmental factor), thus, the present invention makes a big cost saving by replacing transformer with inductance.

### BRIEF DESCRIPTION OF THE DRAWINGS

FIG. 1a illustrates an existing switching power supply circuit which has a buck structure;

FIG. 1b illustrates an existing switching power supply circuit which has a boost structure;

FIG. 1c illustrates an existing switching power supply circuit which has a buck-boost structure;

FIG. 2a illustrates an existing switching power supply circuit which includes a flyback transformer;

FIG. 2b illustrates an existing switching power supply circuit which includes a forward transformer;

FIG. 2c illustrates an existing switching power supply circuit which includes a bridge transformer;

FIG. 3 illustrates a switching power supply circuit according to an embodiment of the present invention; and

FIG. 4 illustrates an equivalent circuit of the switching power supply circuit of the present invention.

### DETAILED DESCRIPTION OF ILLUSTRATED EMBODIMENTS

The technical solutions of embodiments will be clear and completely described as follows by combining the figures of the embodiments of the present invention, and similar labels in the figures represent similar components. Obviously, the embodiments described as follows are merely parts of embodiments of the present invention, but not the all. Based on the embodiments of the present invention, other embodiments created by one of ordinary skill in the art without creative work, all belong to the scope of the present invention.

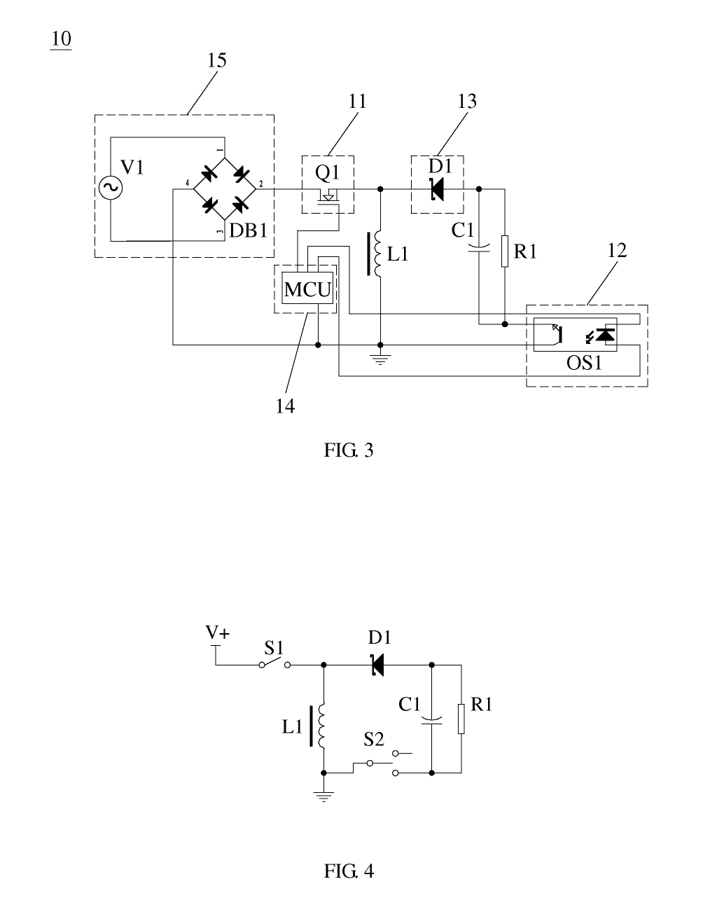

FIG. 3 illustrates a switching power supply circuit according to an embodiment of the present invention. Referring to FIG. 3, a switching power supply isolation circuit 10 of the present invention includes a switching device 11, a signal unidirectional transmission device 12, a unilateral connecting device 13, an inductance L1 and a control module 14. In the above circuit 10, the switching device 11, the inductance 12 and a voltage source 15 are connected in series to form a power supply loop, and the unilateral connecting device 13, the inductance L1, the signal unidirectional transmission device 12 and a load R1 are connected in series to form a load loop, and both of the switching device 11 and the signal unidirectional transmission device 12 are connected with and controlled by the control module 14. Under the control of the control module 14, when the switching device 11 is turned on, the signal unidirectional transmission device 12 is turned off, thereby the power supply loop is working and the inductance L1 starts to store energy; and when the switching device 11 is turned off, the signal unidirectional transmission device 12 is turned on, thereby the load loop is working and the inductance L1 starts to releases energy so as to provide power supply for the load.

In some embodiments, such as this embodiment, the switching device 11 is a switching tube, such as N-channel MOS transistor Q1. The drain electrode of MOS transistor Q1 is connected with the positive electrode of the voltage source 15, its source electrode is connected with the inductance L1 and its grid electrode is connected with a first control terminal of the control module 14. Understandably, in other embodiments, the switching device 11 can be implemented by other devices which can receive pulse signal and change turn-off state under the control of the pulse signal.

In some embodiments, such as this embodiment, the signal unidirectional transmission device is a photoelectric coupler OS1, its two input ends are connected with a second control terminal and a third control terminal of the control module 14, respectively, and its two output ends are connected between the inductance L1 and the load R1. In other embodiments, the signal unidirectional transmission device 12 can be a hall switch.

In some embodiments, such as this embodiment, the unilateral connecting device is a diode D1, its positive electrode is connected with the load R1 and its negative electrode is connected with the inductance L1. In other embodiments, the diode D1 can be replaced by other unilateral connecting device.

In some embodiments, such as this embodiment, the control module 14 is a microcontroller unit (MCU), such as a single chip produced by Microchip Technology Inc. Three of input/output pins of the microcontroller unit are used as the first control terminal, the second control terminal and the third control terminal. The first control terminal is connected with the grid electrode of the MOS transistor Q1, and the second control terminal and the third control terminal are connected with two input ends of the photoelectric coupler OS1, respectively. By means of writing program for the microcontroller unit, it can be configured to output pulses via its three input/output pins, so as to control the on-off state of the MOS transistor Q1 and the photoelectric coupler OS1 as follows: when the MOS transistor Q1 is turned on, the photoelectric coupler OS1 is turned off; and when the MOS transistor Q1 is turned off, the photoelectric coupler OS1 is turned on. Understandably, based on the circuit structure of the power supply loop and the load loop, there has a limitation for the pulse provided to control the two loops and the pulse is determined solely. That is, the above circuit structure determines that the pulse is provided to manage the MOS transistor Q1 and photoelectric coupler OS1 in a certain way. Thus, in other embodiments, the pulse used for managing the MOS transistor Q1 and photoelectric coupler OS1 can be provided by pure hardware circuit composed of logic devices, that is, the control module 14 also can be implemented by pure hardware circuit without programing, which is well known for a person skilled in the art and need not be repeated here.

In some embodiments, such as this embodiment, a capacitor C2 is provided to connect with the load in parallel, so as to provide filter processing to the output voltage which is applied to the load R1.

In some embodiments, such as this embodiment, the voltage source is a DC voltage source which is formed by using rectifier bridge to rectify the mains supply.

FIG. 4 illustrates an equivalent circuit of the switching power supply circuit 10 of the present invention. Referring to FIG. 4, the MOS transistor Q1 is equivalent to a switch Si and the photoelectric coupler OS1 is equivalent to a switch S2. The DC voltage source is provided for supply energy for the whole circuit. The switch S1 and inductance L1 are provided to make up a power supply loop with the DC voltage source; and the inductance L1, diode D1, capacitor C1, load R1 and switch S2 are provided to make up a load loop which has energy source supplied by the self-induced electromotive force of the inductance L1. When the switch S1 is turned on, the switch S2 is turned off, thereby the inductance L1 starts to store energy via the DC voltage source; and when the switch S1 is turned off, the switch S2 is turned on, thereby the inductance L1 starts to releases energy so as to provide power supply for the load R1.

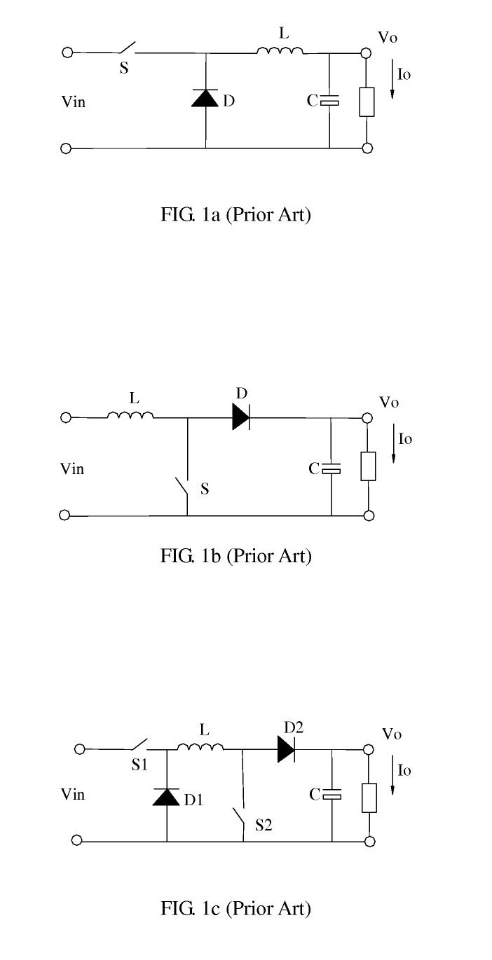

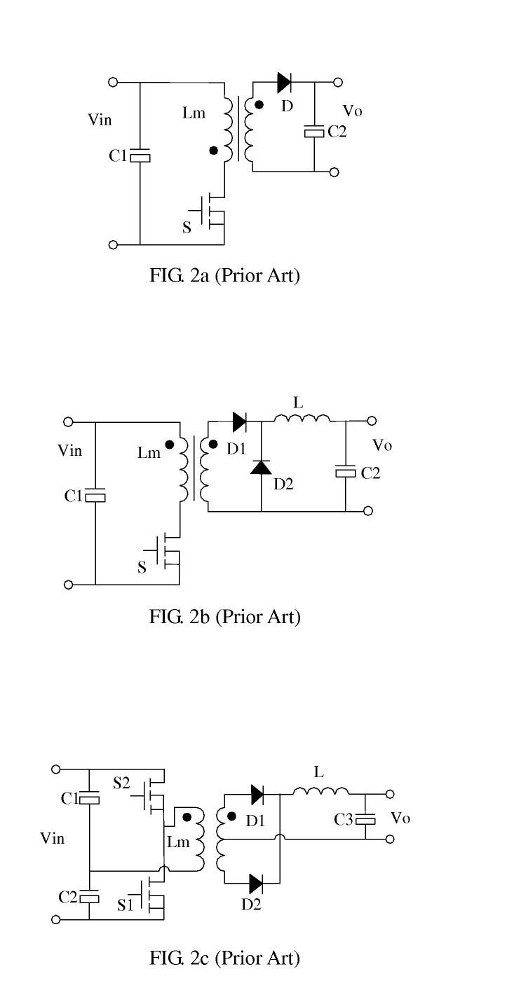

The switching power supply isolation circuit of the present invention is an improvement over the traditional circuit with buck structure shown in FIG. 1a. The present invention is constituted by swapping the position of the inductance and the diode of the buck structure (such structure actually is a buck-boost structure) and adding a signal unidirectional transmission device, so as to form a circuit with new structure called buck-insulation structure. Viewed from the circuit with buck-insulation structure of the present invention, just an inductance L1 is provided to supply power for the load R1, and a diode D1 and photoelectric coupler OS1 are provided to achieve electrical isolation for the DC voltage source.

In conclusion, the switching power supply isolation circuit of the present invention is mainly constituted of a power supply loop and a load loop, thereby achieving a buck-insulation structure. Viewed from power supply mode of the circuits, the power supply mode of existing circuit, by means of utilizing mutual induction phenomenon produced by a transformer to supply power to a secondary load, will cause magnetic flux loss, which leads to low efficiency, thus, compared with the traditional way, the switching power supply isolation circuit of the present invention has higher efficiency by utilizing induced electromotive force produced by the inductance itself to supply power. Viewed from the volume, there are at least two coils needed to make a transformer while there is just one coil needed to make an inductance, thus, the volume of the transformer will be bigger than that of the inductance on equal terms. Thus, compared with the existing circuit, the switching power supply isolation circuit of the present invention can achieve a smaller size. Viewed from the cost, the production process of the transformer is more complicated, needs longer time and higher cost than that of the inductance on equal terms (the same in-out condition and environmental factor), thus, the present invention makes a big cost saving by replacing transformer with inductance.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A switching power supply isolation circuit, comprising a switching device, a signal unidirectional transmission device, a unilateral connecting device, an inductance and a control module, wherein the switching device, the inductance and a voltage source are connected in series to form a power supply loop, and the unilateral connecting device, the inductance, the signal unidirectional transmission device and a load are connected in series to form a load loop, and both of the switching device and the signal unidirectional transmission device are connected with and controlled by the control module;
when the switching device is turned on, the signal unidirectional transmission device is turned off, thereby the power supply loop is working and the inductance starts to store energy; and when the switching device is turned off, the signal unidirectional transmission device is turned on, thereby the load loop is working and the inductance starts to releases energy so as to provide power supply for the load.

2. The switching power supply isolation circuit according to claim 1, wherein said switching device is a MOSFET, which has a drain electrode connected with the positive electrode of the voltage source, a source electrode connected with the inductance and a grid electrode connected with a first control terminal of the control module, pulses provided by the control module being output to the MOSFET so as to control the on-off state of the MOSFET.

3. The switching power supply isolation circuit according to claim 2, wherein said signal unidirectional transmission device is a photoelectric coupler, which has two input ends respectively connected with a second control terminal and a third control terminal of the control module and two output ends respectively connected with the inductance and the load, pulses provided by the control module being output to the photoelectric coupler so as to control the on-off state of the photoelectric coupler.

4. The switching power supply isolation circuit according to claim 3, wherein said unilateral connecting device is a diode, which has a positive electrode connected with the load and a negative electrode connected with the inductance.

5. The switching power supply isolation circuit according to claim 3, wherein said control module is a microcontroller unit, three of input/output pins of the microcontroller unit being used as the first control terminal, the second control terminal and the third control terminal, respectively.

6. The switching power supply isolation circuit according to claim 1, wherein further comprises a filter capacitor connected with the load in parallel.

7. The switching power supply isolation circuit according to claim 1, wherein said voltage source is a DC voltage source which is formed by using rectifier bridge to rectify mains supply.
